(19) United States
(12) Patent Application Publication
(10) Pub. No.: US 2016/0197739 A1
(43) Pub. Date: Jul. 7, 2016

(54) SYSTEM AND A METHOD FOR HOME AUTOMATION NETWORK COMMUNICATION

(71) Applicant: Fibar Group Sp. z o.o., Poznan (PL)

(72) Inventor: Maciej FIEDLER, Poznan (PL)

(21) Appl. No.: 14/612,318

(22) Filed: Feb. 3, 2015

(30) Foreign Application Priority Data
Jan. 5, 2015 (EP) 15461502.5

(51) Int. Cl. H04L 12/28; G05B 15/02

(52) U.S. Cl. CPC H04L 12/282; G05B 15/02

(57) ABSTRACT

A method for home automation network communication, the method comprising the steps of: providing (501) a home network interface device (201); establishing connection (502) between at least one home automation device and the home network interface device (201); connecting (503) a user multimedia device (211) to the home network interface device (201); executing (504) control software at the user multimedia device (211); controlling (505) the at least one home automation device, using the control software operated by the user multimedia device (211); and routing (506) control messages, generated in response to user actions, to the home network devices via the home network interface device (201).

### TECHNICAL FIELD

The present disclosure relates to home automation network communication. It relates particularly to distribution of communication resources over various devices in the home automation network.

### BACKGROUND

The known concept of home automation relates to a residential extension of building automation. It is automation of the home, housework or household activity. Home automation may include centralized control of lighting, HVAC (heating, ventilation and air conditioning), appliances, security locks of gates and doors and other systems, to provide improved convenience, comfort, energy efficiency and security.

The popularity of home automation has been increasing greatly in recent years due to much higher affordability and simplicity.

Home automation gateways are known to provide a capability to control devices by communicating with the devices over home automation protocols, such as Zigbee or Z-Wave. Home automation gateways are typically relatively high-power computing devices, comprising resources with processing power enough to operate a user interface application via which the user can manage various devices and a management application which sets up and coordinates operation of various home devices.

A US patent publication US20140266670A1 discloses a typical home gateway for automated surveillance and alert triggering. Input devices such as sensors, camera are positioned in a building to be monitored. A gateway module receives and processes inputs from the input devices and checks for occurrence of any event. Upon detecting any event, the gateway module sends information related to the detected event to a configured user device. Further, the gateway records audio and/or video contents related to the detected event and store the recorded data in an associated memory module. The user can remotely access and view the stored contents and can trigger any pre-configured action remotely from the user device.

As already mentioned, a drawback of such an arrangement is that the home gateway is very heavy on resources (computational as well as memory) and requires a significant expense to be purchased. Home gateways become more and more sophisticated and thus more complex.

There is therefore a need to provide an alternative approach to communication in a home automation network, which would allow use of a home gateway that could be lightweight, in terms of hardware/and software complexity, and cost effective.

### SUMMARY

There is presented a method for home automation network communication. The method may comprise the steps of: providing a home network interface device; establishing connection between at least one home automation device and the home network interface device; connecting a user multimedia device to the home network interface device; executing control software at the user multimedia device; controlling the at least one home automation device, using the control software operated by the user multimedia device; and routing control messages, generated in response to user actions, to the home network devices via the home network interface device.

The method may further comprise, at the home network interface device, translating the messages from a first communication protocol, supported by the user multimedia device and the control software, to a second communication protocol, supported by the home automation device.

The first communication protocol may be a USB protocol.

The second communication protocol may be a Z-Wave protocol.

Control software operable at the user multimedia device may be configured to generate a graphical user interface.

The user multimedia device may be a tablet computer or a smartphone.

The user multimedia device may be supplied with power by the home network interface device.

There is also presented a system for home automation network communication. The system may comprise: a home network interface device; at least one home automation device communicatively coupled to the home network interface device; a user multimedia device, communicatively coupled to the home network interface device; a control software at the user multimedia device; the control software being configured to control the at least one home automation device, using the control software operated by the user multimedia device; wherein the system is configured to route control messages, generated in response to user actions, to the home network devices via the home network interface device.

The home network interface device may be configured to translate the messages from a first communication protocol, supported by the user multimedia device and the control software, to a second communication protocol, supported by the home automation device.

The home network interface device may have a form of a frame configured to enclose the user multimedia device having a form of a tablet computer or a smartphone.

The home network interface device may have a frame-like base mountable on a wall.

The home network interface device may comprise a connector to power supply cables.

The user multimedia device may be powered from the home network interface device.

### BRIEF DESCRIPTION OF FIGURES

These and other objects presented herein are accomplished by providing a system and method for home automation network communication. Further details and features of the presented system and method, their nature and various advantages will become more apparent from the following detailed description of the preferred embodiments shown in a drawing, in which:

FIG. 1 presents a diagram of a typical home network system with home automation functions;

FIG. 2 presents a diagram of the system according to the present disclosure;

FIG. 3 presents abstract layers of a typical home gateway for home automation; and

FIG. 4 presents abstract layers of a home gateway arrangement according to the present disclosure;

FIG. 5 presents a method according to the present disclosure; and

FIG. 6 presents an example of an embodiment of the home network interface device.

It should be understood that the aforementioned embodiments are merely example implementations, and that claimed subject matter is not necessarily limited to any particular aspect of these example implementations.

### NOTATION AND NOMENCLATURE

Some portions of the detailed description which follows are presented in terms of data processing procedures, steps or other symbolic representations of operations on data bits that can be performed on computer memory. Therefore, a computer executes such logical steps thus requiring physical manipulations of physical quantities,

Usually these quantities take the form of electrical or magnetic signals capable of being stored, transferred, combined, compared, and otherwise manipulated in a computer system. For reasons of common usage, these signals are referred to as bits, packets, messages, values, elements, symbols, characters, terms, numbers, or the like.

Additionally, all of these and similar terms are to be associated with the appropriate physical quantities and are merely convenient labels applied to these quantities. Terms such as “processing” or “creating” or “transferring” or “executing” or “determining” or “detecting” or “obtaining” or “selecting” or “calculating” or “generating” or the like, refer to the action and processes of a computer system that manipulates and transforms data represented as physical (electronic) quantities within the computer's registers and memories into other data similarly represented as physical quantities within the memories or registers or other such information storage.

A computer-readable (storage) medium, such as referred to herein, typically may be non-transitory and/or comprise a non-transitory device. In this context, a non-transitory storage medium may include a device that may be tangible, meaning that the device has a concrete physical form, although the device may change its physical state. Thus, for example, non-transitory refers to a device remaining tangible despite a change in state.

As utilized herein, the term “example” means serving as a non-limiting example, instance, or illustration. As utilized herein, the terms “for example” and “e.g.” introduce a list of one or more non-limiting examples, instances, or illustrations.

### DETAILED DESCRIPTION

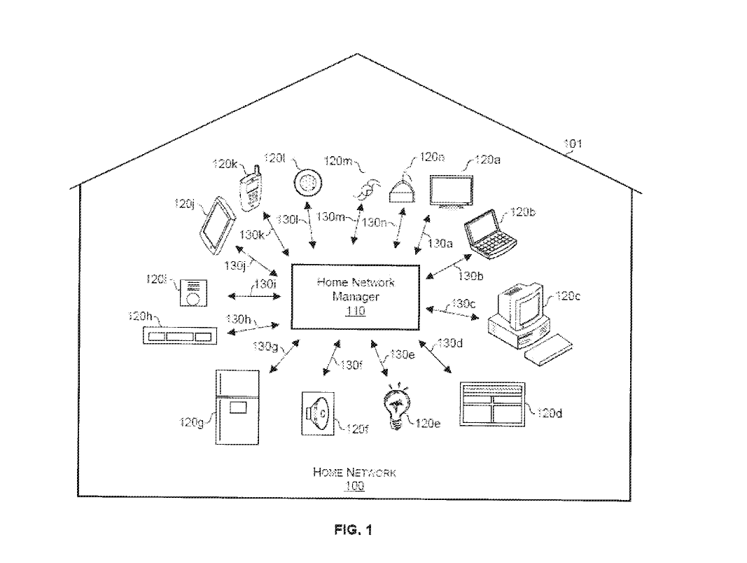

FIG. 1 presents a diagram of a typical home network system with home automation functions. Referring to FIG. 1, there is shown a home network 100.

The home network 100 may correspond to a location 101. The location 101 may, for example, correspond to a residence (e.g., home, apartment) or non-residence premises (e.g., small business, school, library, factory, etc.).

In this regard, the home network 100 may, for example, comprise a plurality of home network elements, such as, for example, a plurality of home network elements 120a-120n.

The home network elements (e.g., home network elements 120a-120n) may, for example, comprise one or more devices (e.g., electrical devices), systems, fixtures, appliances, and/or other circuitry.

The home network elements (e.g., home network elements 120a-120n) may comprise, for example, one or more televisions 120a, one or more computers (e.g., laptop computer 120b, desktop computer 120c), one or more personal and/or handheld devices (e.g., tablet 120j, mobile/smart phone 120k, smart watch 120m), one or more multimedia devices and/or components (e.g., speakers 120f), one or more structural fixtures (e.g., windows/window blinds 120d,), one or more lighting and/or electrical fixtures 120e, one or more appliances (e.g., refrigerator 120g), one or more environmental sensory devices 120h (e.g., thermometers, humidity meters), one or more security devices 120i (e.g., a smoke detector, a carbon monoxide detector, a security alarm, a motion detector), one or more sensors and/or controller (e.g., intelligent motion sensor 120l, RGBW controller 120n) and/or other devices.

The home network 100 may incorporate a home network manager 110 for implementing various aspects of the present disclosure, in order to communicate with different kinds of home automation devices, configure these devices as well as allow a user to operate and setup these home automation devices.

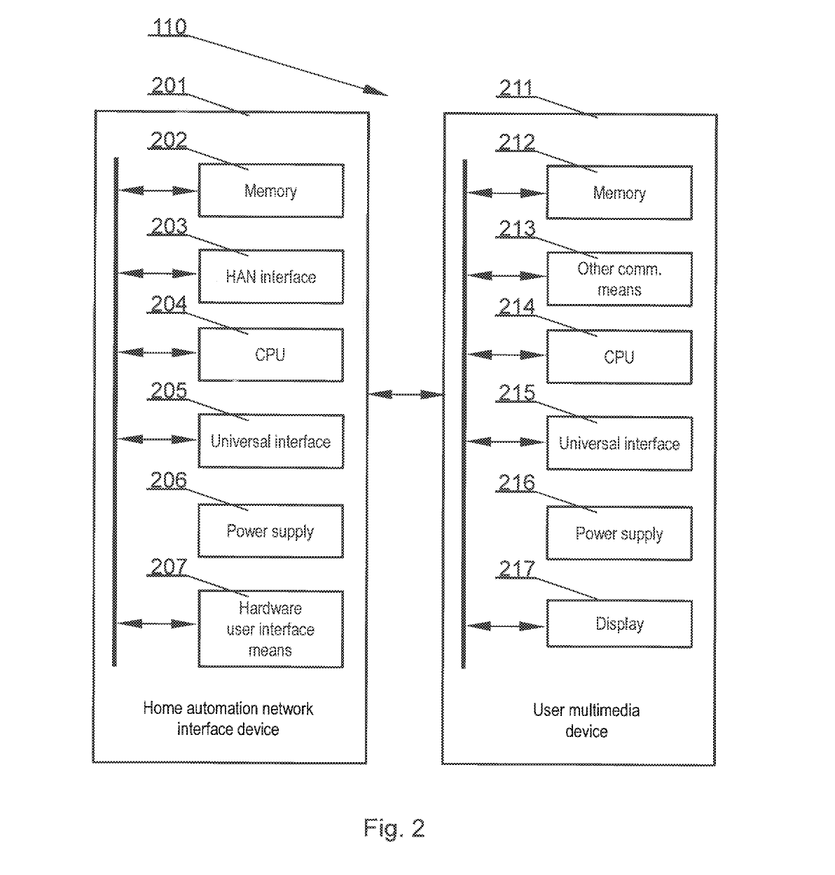

FIG. 2 presents a diagram of the home network manager 110 for handling the home automation network communication. The interface device is split into two elements: a lightweight home network interface device 201 and a user multimedia device 211 communicatively coupled to the home network interface device 201.

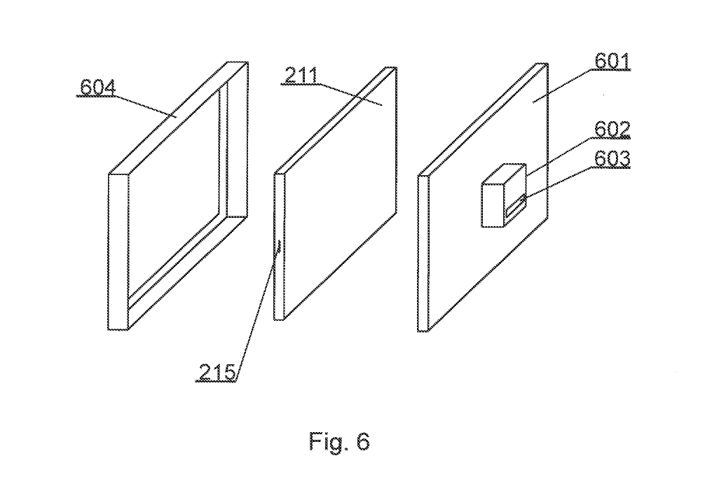

In one embodiment, the home network interface device 201 may be implemented in a form of a frame-like box, into which the user multimedia device 211, such as a tablet, may be fitted. The frame may have a shape as shown in FIG. 6 by way of example. The frame-like box may comprise a flat base 601 which has a connector 602 configured to fit into a standard wall installation box, comprising connectors 603 for electric power cables. The connector 602 may house electronic circuitry of the interface device 201. To the flat base 601 a frame 604 is mountable such that a user multimedia device 211 can fit between the base 601 and the frame 604. The frame 604 and/or base 601 may comprise a connector (not shown) for connecting signal lines and power lines to the connector 215 of the multimedia device 211, such as an USB connector. Alternatively, the interface device 201 may be connectable with the multimedia device 211 via wireless transmission means.

The home network interface device 201 is a simple, lightweight device comprising a simple CPU or a controller 204, which cooperates with a memory 202 and a home automation network (HAN) interface 203.

The home network interface device 201 comprises a communication interface, preferably supporting also power supply function such as a USB communication interface 205. This communication interface is preferably used to communicate with the user multimedia device 211 and to provide power to the user multimedia device 211.

Further, the home network interface device 201 comprises a power supply 206 and preferably a hardware user interface 207 such as hardware buttons and/or LED's indicating status of the home network interface device 201.

As can be readily seen, the home network interface device 201 does not need to operate complex software for communicating with a user, for example via a graphical user interface. These functions are handled by the user multimedia device 211, which is connected to the home network interface device 201 via the interface 205.

The user multimedia device 211 can be a tablet computer or a smartphone and comprises components such as a CPU 214, a memory 212, communication means 213 for handling communication protocols such as Bluetooth, Wi-Fi, NFC or the like. Further, the user multimedia device 211 comprises a display 217, a power supply 216 and a communication interface, preferably supporting also power supply function such as a USB communication interface 215 via which the device 211 communicates with the home network interface device 201.

As the user multimedia device 211 comprises a powerful CPU 214 and a display 217, this device is able to execute complex software with graphical user interface.

In the prior art solutions, it was the home gateway that was generating GUI and presenting it for the user for manipulation, for example on a television display screen or on a screen of externally connected tablet or smartphone.

According to the novel approach presented herein, the home network interface device 201 is a lightweight component, while the applications, heavy on resources, are executed in the user multimedia device 211 connected to the home network interface device 201.

Nowadays, it is common for people to have at least one tablet and/or smartphone device at home. Therefore, home network interface device 201 can be constructed as a lightweight, low-resources device, shifting parts of its software and utilizing the hardware of the user multimedia device 211, to make the whole home automation network communication system less expensive and more affordable to users.

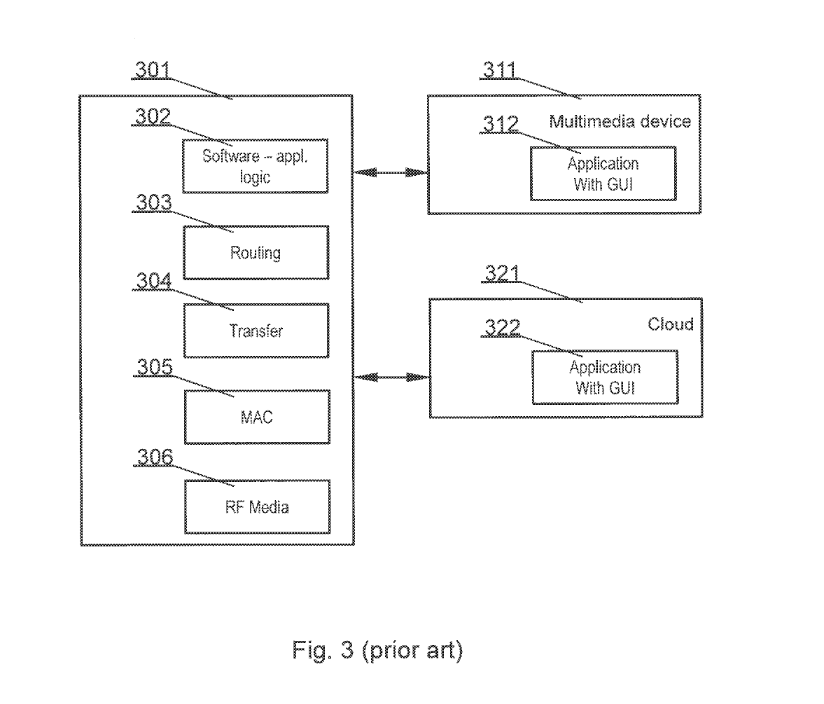

FIG. 3 presents abstract layers of a typical prior art home network manager, such as home gateway, for home automation network communication. The home gateway 301 implements communication at different abstraction layers 302-306. The lowest layer is 306 at the radio-frequency media communication layer. This layer is typically a hardware layer. On top of that there is a MAC addressing layer 305 responsible for hardware addressing. A further layer is a transfer layer 304 responsible for data transmission at the level of TCP or UDP protocols, Higher in the abstraction levels, there is a data routing layer 303 and software and application logic 302 responsible for communicating with users and generating graphical user interface as well as processing data and events. In this model, there of course exist devices coupled to the home gateway 301 such as multimedia devices 311 and cloud services 321 that may be reached via a WAN connectivity,

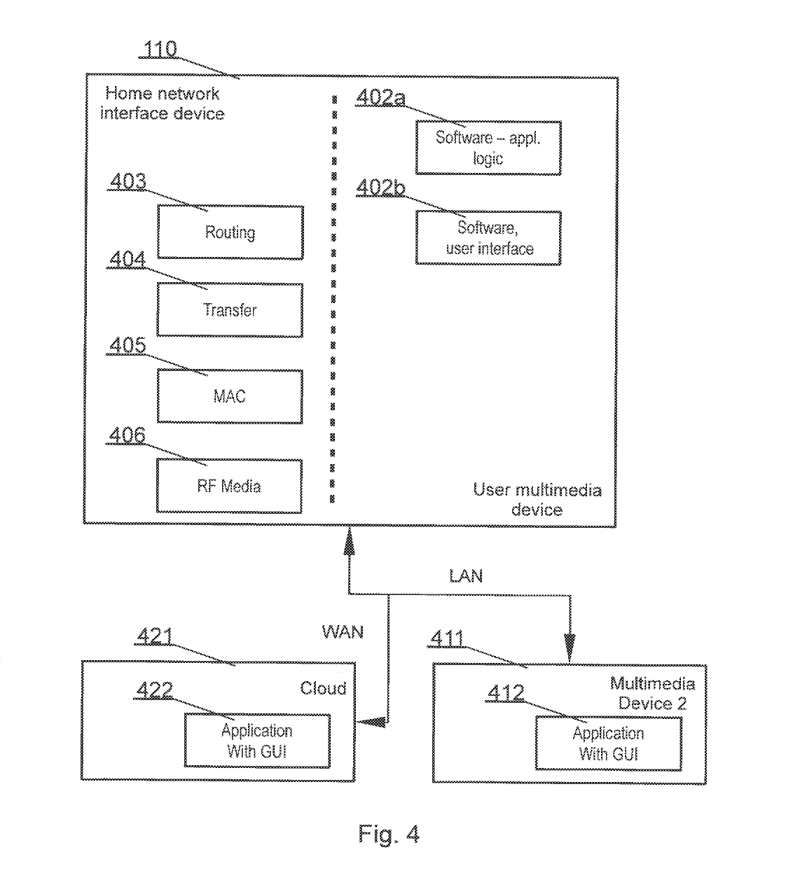

FIG. 4 shows abstract layers of a home gateway arrangement according to the novel concept presented herein. The model differs in the definition of the home network manager 110, which is split into two modules: a lightweight home network interface device and a user multimedia device.

The user multimedia device handles the software and application logic layer 402a (formerly being part of the home gateway as a single device) as well as software providing user interface 402b that allows to monitor devices on the home automation network as well as to configure such devices and utilize their resources. The lower layers 403-406 (equivalent to layers 303-306 described above) are handled by the lightweight home network interface device.

The user multimedia device may be connectable to the home network interface device periodically, if there is a need to communicate with some home network devices, e.g. to check the status of the device or send commands to the device.

Moreover, the user multimedia device may be connected to the home network interface device in a permanent manner, to handle network management functionality, e.g. to continuously monitor operation of home network devices or to generate commands, in an automatic manner, to the home network devices if a need arises (e.g. in response to a preset timer or in response to status of the same or other network devices).

Thus, the prior art gateway is now split and operates as a home network interface device, preferably in a form of a hardware frame component, and a user multimedia device providing different resources as well as a display.

Due to this arrangement, not only the user may be offered a more affordable home network interface device but also any updates to hardware or software of the home network interface device are also more affordable as the user may still use his multimedia device with a new home network interface device. Also when the user updates his multimedia device to a new model, this new model will also be supported by the lightweight home network interface device.

The system presented in FIG. 4 further allows communication with devices coupled to the home network manager 110 such as other user multimedia devices 411 and cloud services 421 that may be reached via a WAN connectivity. The entities 411 and 421 may communicate with the home network interface device or with the user multimedia device, depending on the system configuration.

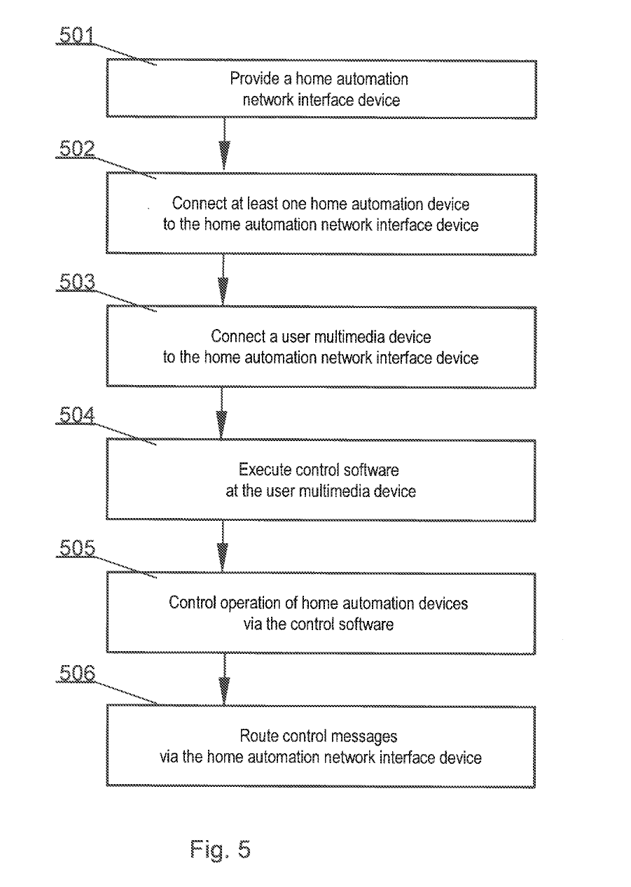

FIG. 5 depicts a method for handling communication over the home automation network according to the present concept. The method starts at step 501 from providing a home network interface device 201 (as previously described). Next, at least one home automation device is connected 502 to the home network interface device 201. Subsequently, at step 503, a user multimedia device 211 is connected to the home network interface device 201. At step 504, control software is executed at the user multimedia device 211.

The control software may be downloaded from the home network interface device 201 or from external channels, such as from Internet. The system operator may provide various control software versions, designed to operate with various operating systems handled by the user multimedia devices 211. In this manner, the system can be universal and used with various types of user multimedia devices 211. Subsequently, at step 505, various home automation devices may be controlled by the user using the control software operated by the user multimedia device 211. In step 506 the control messages generated in response to user actions are routed to the home network devices via the home network interface device 201, which translated the messages from one communication protocol (handled by the user multimedia device and the control software, such as USB) to another communication protocol (handled by the home automation device, such as Z-Wave).

Therefore, the home network interface device transforms data requests of a user multimedia device into a home automation network protocol messages that are output from the home network interface device to the at least one home automation device communicatively connected to the home network interface device. It will be a typical setup that the at least one home automation device connected to the home network interface device cannot be directly controlled with the user multimedia device, but only via the application of the home network interface device, operating as a lightweight home gateway.

Thus, the lightweight home network interface device replaces the complex home gateway and together with a user multimedia device, which typically the user already has, creates a full features home gateway.

The presented method and system provide a useful embodiment of a home network interface device, and its tangible result is that there is used customer's premises equipment in order to reduce the complexity of a typical home gateway equipped with a home automation services. Therefore, the presented method and system provide a useful, concrete and tangible result.

The aforementioned home network interface device is a particular machine that transforms data requests of a user multimedia device into a home automation network protocol messages. Therefore the machine or transformation test is fulfilled and that the idea is not abstract.

It can be easily recognized, by one skilled in the art, that the aforementioned method for home automation network communication may be performed and/or controlled by one or more computer programs. Such computer programs are typically executed by utilizing the computing resources in a computing device. Applications are stored on a non-transitory medium. An example of a non-transitory medium is a non-volatile memory, for example a flash memory while an example of a volatile memory is RAM. The computer instructions are executed by a processor. These memories are exemplary recording media for storing computer programs comprising computer-executable instructions performing all the steps of the computer-implemented method according the technical concept presented herein.

While the method and system presented herein have been depicted, described, and has been defined with reference to particular preferred embodiments, such references and examples of implementation in the foregoing specification do not imply any limitation on the presented method and system, It will, however, be evident that various modifications and changes may be made thereto without departing from the broader scope of the technical concept. The presented preferred embodiments are exemplary only, and are not exhaustive of the scope of the technical concept presented herein.

Accordingly, the scope of protection is not limited to the preferred embodiments described in the specification, but is only limited by the claims that follow.

1. A method for home automation network communication, the method comprising the steps of:
providing a home network interface device;
establishing connection between at least one home automation device and the home network interface device;
connecting a user multimedia device to the home network interface device;
executing control software at the user multimedia device;
controlling the at least one home automation device, using the control software operated by the user multimedia device; and
routing control messages, generated in response to user actions, to the home network devices via the home network interface device.

2. The method according to claim 1, further comprising, at the home network interface device, translating the messages from a first communication protocol, supported by the user multimedia device and the control software, to a second communication protocol, supported by the home automation device.

3. The method according to claim 1 wherein the first communication protocol is a USB protocol.

4. The method according to claim 1 wherein the second communication protocol is a Z-Wave protocol.

5. The method according to claim 1 wherein control software operable at the user multimedia device is configured to generate a graphical user interface.

6. The method according to claim 1 wherein the user multimedia device is a tablet computer or a smartphone.

7. The method according to claim 1 wherein the user multimedia device is supplied with power by the home network interface device.

8. A system for home automation network communication, the system comprising:
a home network interface device;
at least one home automation device communicatively coupled to the home network interface device;
a user multimedia device, communicatively coupled to the home network interface device;
a control software at the user multimedia device;
the control software being configured to control the at least one home automation device, using the control software operated by the user multimedia device; and
wherein the system is configured to route control messages, generated in response to user actions, to the home network devices via the home network interface device.

9. The system according to claim 8, wherein the home network interface device is configured to translate the messages from a first communication protocol, supported by the user multimedia device and the control software, to a second communication protocol, supported by the home automation device.

10. The system according to claim 8, wherein the home network interface device has a form of a frame configured to enclose the user multimedia device having a form of a tablet computer or a smartphone.

11. The system according to claim 10, wherein the home network interface device has a frame-like base mountable on a wall.

12. The system according to claim 10, wherein the home network interface device comprises a connector to power supply cables.

13. The system according to claim 8, wherein the user multimedia device is powered from the home network interface device.
